(19) United States
(12) Patent Application Publication
(10) Pub. No.: US 2026/0196848 A1
(43) Pub. Date: Jul. 9, 2026

(54) SYSTEM AND METHOD FOR MANAGING ELECTRICAL POWER HARNESSED FROM ELECTRICALLY DRIVEN LOADS

(71) Applicant: Caterpillar Paving Products Inc., Brooklyn Park, MN (US)

(72) Inventor: Nicholas Alan Oetken, Brooklyn Park, MN (US)

(73) Assignee: Caterpillar Paving Products Inc., Brooklyn Park, MN (US)

(21) Appl. No.: 19/013,025

(22) Filed: Jan. 8, 2025

(51) Int. Cl. H02J 7/14; B60L 50/51; B60L 58/12; E01C 19/28; H02J 7/00; H02K 7/02; H02P 3/14

(52) U.S. Cl. CPC H02J 7/1476; B60L 50/51; B60L 58/12; H02J 7/865; H02J 7/977; H02K 7/02; H02P 3/14; B60L 2200/40; B60L 2210/30; B60L 2210/44; B60L 2240/545; E01C 19/282

(57) ABSTRACT

A method for managing electrical power harnessed from an electrically driven load includes detecting a deceleration event of the electrically driven load; determining a battery charge rate limit of a battery powering a first electric motor driving the electrically driven load; causing, in response to the battery charge rate limit, at least a first part of the electrical power to power a second electric motor during the deceleration event to accommodate a reduction of a charging rate of the battery from the electrical power to a reduced charging rate.

### TECHNICAL FIELD

The present disclosure relates to machines, such as asphalt compactors, having one or more electrically driven loads. More particularly, the present disclosure relates to managing electrical power harnessed from the electrically driven loads.

### BACKGROUND

Machines, such as asphalt compactors, may include electrically driven loads, such as traction devices, vibratory motors applicable during a compaction operation, etc., which may be powered by one or more electric motors. When the machine is operational, an electrically driven load may source power from the machine's electrical power source, such as a battery, e.g., a Lithium-Ion battery, for an acceleration of the electrically driven load. Also, such electrically driven loads may return the power to the machine's electrical power source (e.g., a battery) during a deceleration of the electrically driven load.

A battery's charge rate and discharge rate typically depend upon a variety of factors, such as battery's state of charge and battery's temperature. In cold weather conditions, e.g., when the machine operates in low-temperature regions, deserts, and/or under frequently changing weather conditions, the battery may sustain capacity constraints, causing the electrical power source to be charged inefficiently and/or to be charged at a relatively lowered rate than when the machine operates in normal weather conditions. Generally, the battery's charge rate, discharge rate, and capacity constraints or limits, are determined by a Battery Management System (BMS) of the battery. Further, the same may be communicated to a machine controller. During deceleration, such constraints may cause the electrically driven load to take relatively longer time to stop than when the machine operates under normal weather conditions.

CN105730446B relates to a storage battery and flywheel combined type idling and braking energy recycling system. Two modes of storing energy through a storage battery and storing energy through a flywheel are combined for energy storage. An electromagnetic clutch ‘a’ and an electromagnetic clutch ‘b’ are controlled through an electronic control unit to be engaged and disengaged, and a power transmission route is controlled. When an automobile is started, the electromagnetic clutch ‘a’ is engaged, and a motor/electric generator serves as motor output power to drive an engine flywheel to rotate. When the automobile is braked, the electromagnetic clutch ‘a’ and the electromagnetic clutch ‘b’ are engaged at the same time, so that the engine flywheel drives the energy storage flywheel to rotate to recycle braking energy in an energy storage mode of the energy storage flywheel. When the energy storage flywheel releases energy, the automobile is assisted in starting and acceleration, energy, left after starting, of the energy storage flywheel is recycled through the motor/electric generator for power generation. In the idling process, the electromagnetic clutch ‘a’ is engaged, the motor/electric generator serves as an electric generator for generating power, and energy consumed in the idling process is recycled. Idling and braking energy is recycled, so that energy waste is reduced, and the fuel efficiency is improved.

### SUMMARY

In one aspect, the present disclosure discloses a method for managing electrical power harnessed from an electrically driven load in a machine. The method includes detecting, by a control system, a deceleration event of the electrically driven load and determining, by the control system, a battery charge rate limit of a battery powering a first electric motor driving the electrically driven load. Further, the method includes causing, by the control system, in response to the battery charge rate limit, at least a first part of the electrical power to power a second electric motor during the deceleration event to accommodate a reduction of a charging rate of the battery from the electrical power to a reduced charging rate.

In another aspect, the disclosure relates to a system for managing electrical power harnessed from an electrically driven load in a machine. The system includes an auxiliary electric motor to be operably coupled to a main electric motor. The main electric motor is powered by a battery to drive the electrically driven load. Further, the system includes a control system configured to detect a deceleration event of the electrically driven load and determine a battery charge rate limit of the battery. Further, the control system is configured to cause, in response to the battery charge rate limit, at least a first part of the electrical power to power the auxiliary electric motor during the deceleration event to accommodate a reduction of a charging rate of the battery from the electrical power to a reduced charging rate.

In yet another aspect, the disclosure is directed to a machine. The machine includes a battery, an electrically driven load to perform work, a main electric motor powered by the battery to drive the electrically driven load, and a system for managing electrical power harnessed from the electrically driven load. The system includes an auxiliary electric motor operably coupled to the main electric motor. Further, the system includes a control system configured to detect a deceleration event of the electrically driven load and determine a battery charge rate limit of the battery. The control system is further configured to cause, in response to the battery charge rate limit, at least a first part of the electrical power to power the auxiliary electric motor during the deceleration event to accommodate a reduction of a charging rate of the battery from the electrical power to a reduced charging rate.

### BRIEF DESCRIPTION OF THE DRAWINGS

FIG. 1 is a side view of an exemplary machine having one or more electrically driven loads, in accordance with an embodiment of the present disclosure;

FIG. 2 is a schematic view of a system for managing electrical power harnessed from any one or more electrically driven loads of the machine of FIG. 1, in accordance with an embodiment of the present disclosure;

FIG. 3 is a graphical representation indicating an exemplary manner in which the electrical power from the electrically driven loads are managed, in accordance with an embodiment of the present disclosure; and

FIG. 4 is a flowchart illustrating a method for managing electrical power harnessed from the electrically driven loads of the machine, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201, could refer to one or more comparable components used in the same or different depicted embodiments.

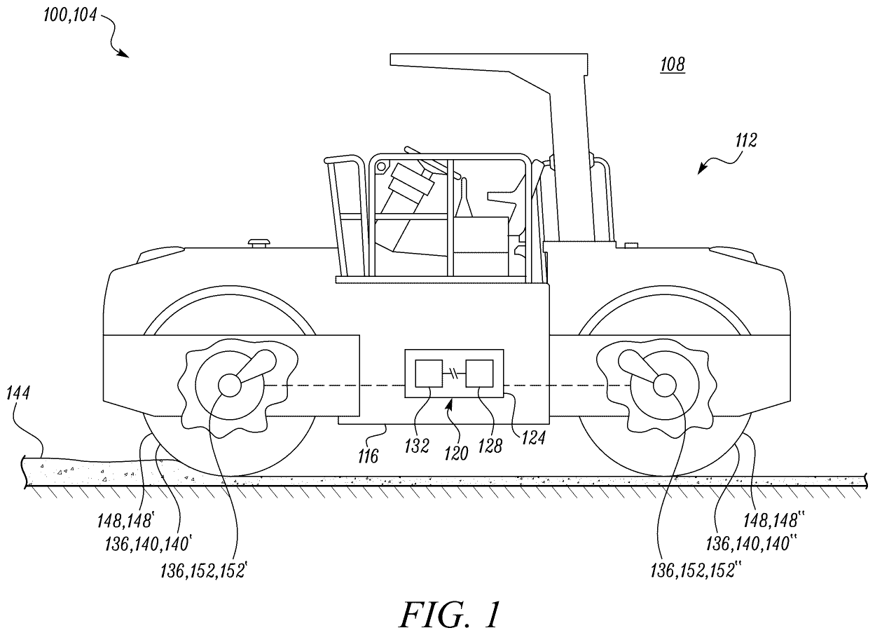

Referring to FIG. 1, an exemplary machine, i.e., a machine 100, is illustrated. The machine 100 may include a mobile machine 104 capable of performing and accomplishing various tasks at a worksite 108. As an example, the machine 100 may correspond to a compactor machine 112 configured to perform a compaction operation at the worksite 108. Several aspects of the present disclosure are described in relation to the compactor machine 112. However, such references to the compactor machine 112 are exemplary, and aspects of the present disclosure may be suitably extended to various other machines, such as graders, scrapers, excavators, loaders, dozers, dump trucks, pavers, and the like machines, with such extensions being contemplatable by those skilled in the art. Therefore, without limitation, the machine 100 may embody or represent dozer machines that may carry out dozing operations, including earth moving, material piling, etc., by use of a blade and/or a moldboard; paving machines that may perform road laying or pavement laying operations; and/or milling machines that may engage and scrape off one or more layers of a road surface. One or more aspect of the present disclosure may be applicable to stationary machines, such as generator sets, as well. In some embodiments, the machine 100 may be an electrically operated machine or a battery operated machine.

The machine 100 may include a frame 116 and a power system 120 supported on the frame 116. The power system 120 may include a battery 124 and/or other electrical power generation means (not shown) known to those of skill in the art. The battery 124 may be a Lithium-Ion battery, although other battery types may be contemplated. Further, the battery 124 may include a Battery Management System (BMS) 128 that may be configured to monitor various parameters, e.g., operational parameters, such as a state of charge of the battery 124, a charging rate of the battery 124, a charge depletion rate (interchangeably referred to as discharge rate) of the battery 124, etc. The battery 124 may also include, either as part of the BMS 128 or independent of the BMS 128, a battery temperature sensor 132 that may be configured to detect a temperature of the battery 124.

The machine 100 may also include electrically driven loads 136. As an example, the electrically driven loads 136 may include one or more traction devices 140, see a first traction device 140′ and a second traction device 140″, of the machine 100, each of which may be powerable by the battery 124. The traction devices 140 may provide motive force to the machine 100 to enable the machine 100 to move over a surface 144 of the worksite 108. The electrically driven loads 136 may, additionally or optionally, also include one or more implements 148 (of the machine 100) that may be applied to perform work at the worksite 108. In the case the machine 100 includes the compactor machine 112, the implements 148 may correspond to the machine's compactor drums—e.g., a first compactor drum 148′ and a second compactor drum 148″, as shown. Moreover, said compactor drums 148′, 148″ may correspond to the first traction device 140′ and the second traction device 140″ of the machine 100. The compactor drums 148′, 148″ may be configured to be rolled over the surface 144 to perform the compaction operation over the surface 144.

The compaction operation, i.e., a work performed by the machine 100, may include moving or rolling the compactor drums 148′, 148″ over the surface 144 to compact an underlying material of the surface 144 to a suitable extent of compaction. The compaction operation may involve an application of pressure on the surface 144 by the compactor drums 148′, 148″ that may cause compression and densification of the underlying material, such as soil, concrete, asphalt, and/or landfill, helping the machine 100 achieve an acceptable surface finish on the surface 144. In cases where the machine 100 differs from the compactor machine 112, the implements 148 may vary to include one or more other implements such as a blade or a bucket. Such implements, when powerable, at least party or fully, by electrical power, may also correspond to electrically driven loads of those corresponding machines. Applications of the aspects of the present disclosure may be suitably extended and applied to such electrically driven loads as well, with each such application falling within the ambit of the claimed subject matter.

Apart from the traction devices 140 (and/or the implements 148), the electrically driven loads 136 may include one or more vibratory mechanisms 152, e.g., a first vibratory mechanism 152′ and a second vibratory mechanism 152″. As an example, the first vibratory mechanism 152′ may be associated with the first traction device 140′ and the second vibratory mechanism 152″ may be associated with the second traction device 140″. The vibratory mechanisms 152 may be configured to impart a compaction effort to compact the surface 144 during the compaction operation. For example, the vibratory mechanisms 152 may be configured to make the corresponding compacting drums (e.g., the first compactor drum 148′ and the second compactor drum 148″) vibrate with a predetermined frequency and/or amplitude, depending on the requirements of the compaction operation and/or the finish on the surface 144 that is to be attained.

The machine 100 may include various other electrically driven loads, such as hydraulic pumps and/or devices associated with other sub-systems of the machine 100, and not all electrically driven loads 136 are exhaustively listed here for sake of brevity. Those in the art may contemplate additional devices and equipment which may be driven by electrical power (e.g., from the battery 124), and which may correspond to electrically driven loads 136 of the machine 100. Further, although the electrically driven loads 136 are described in conjunction with, and in reference to, the compactor machine 112, aspects of the present disclosure can be equitably applied to electrically driven loads of various other machines, such as those that are discussed above.

For the purposes of the present disclosure, the electrically driven loads 136 of the machine 100 may be referred to as in the singular—i.e., electrically driven load 136 with the understanding that the electrically driven load 136 may be representative of one or more electrically driven loads. With the foregoing description, it may be noted that during an operation of the machine 100, the electrically driven load 136 may sustain - an acceleration defining an acceleration event, e.g., when the electrically driven load 136 is powered up for a performance of a work, and a deceleration defining a deceleration event, e.g., when the electrically driven load 136 is powered down to stop, halt, and/or retire from the performance of the work.

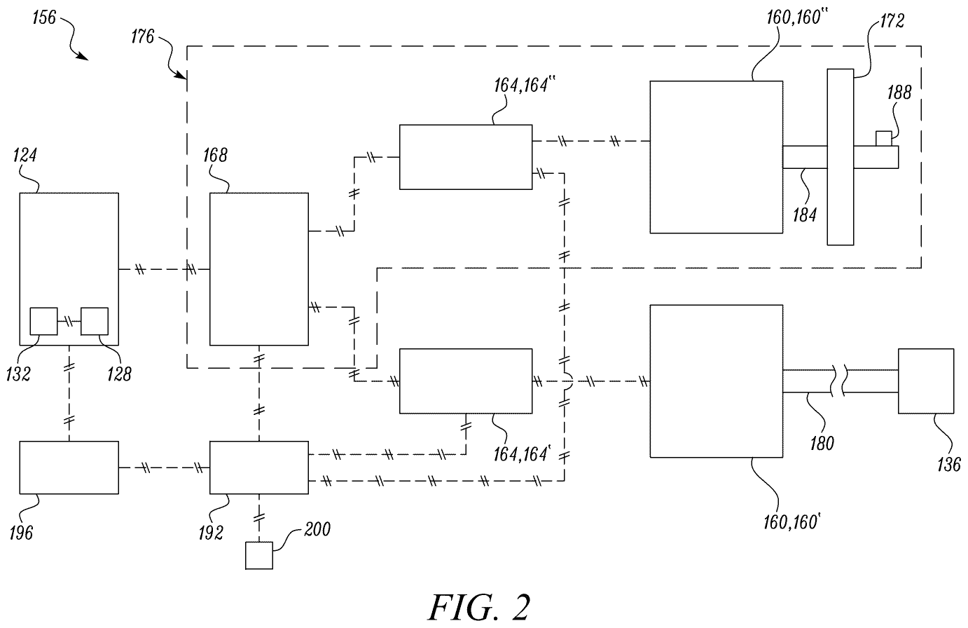

Referring to FIG. 2, the machine 100 may include a powertrain 156 to facilitate a controlled supply or transfer of motive power between the battery 124 and the electrically driven load 136. The powertrain 156 may include various components, such as one or more electric motors 160, e.g., a first electric motor 160′ and a second electric motor 160″, and multiple converter controllers 164, e.g., a first converter controller 164′ and a second converter controller 164″. Further, the powertrain 156 may also include a power distribution unit (PDU) 168 and a flywheel 172. According to one or more aspects of the present disclosure, the second electric motor 160″, the second converter controller 164″, and the PDU 168, may form components of a system 176 that manages electrical power harnessed from the electrically driven load 136, e.g., during the deceleration event of the electrically driven load 136. For ease in reference, said electrical power may be referred to as ‘harnessed electrical power’. Harnessing of electrical power may be possible since the first electric motor 160′ may act as a generator, providing electrical regeneration, during the deceleration event. In some embodiments, the first converter controller 164′, may form part of the system 176, as well. Details related to each of these components shall now be discussed.

The first electric motor 160′ may be a main electric motor of the powertrain 156. The first electric motor 160′ may be configured to be powered by the battery 124 to drive the electrically driven load 136. Further, although referred to in the singular, the first electric motor 160′ may be representative of multiple first electric motors, e.g., that may be mechanically combined via a gear or gear train or a transmission arrangement (not shown) such that they can work in concert. By way of receiving electrical power from the battery 124, the first electric motor 160′ may include a stator/rotor arrangement that when suitably energized may produce a torque for driving a first mechanical link 180 (which may be a solid shaft) associated with the first electric motor 160′. The electrically driven load 136 may be coupled to the first mechanical link 180 and may receive the torque such that rotary motion from the first electric motor 160′ may be induced and transferred within/to the electrically driven load 136. In some examples, the torque may be transmitted to the electrically driven load 136 from the first electric motor 160′ through a transfer case and/or through a gear box (not shown). The first electric motor 160′ may be any known AC or DC motor and may include any one or more of a permanent magnet motor, an induction motor, a switched-reluctance motor, and/or a combination of the above, and may also be sealed, brushless, and/or liquid cooled, in some cases.

The second electric motor 160″ may be an auxiliary electric motor of the powertrain 156 and/or the system 176 and may be operably coupled to the first electric motor 160′. Although not limited, the second electric motor 160″ may be of the same type and/or specification as the first electric motor 160′. In some embodiments, however, the second electric motor 160″ may have a relatively lower capacity and/or may produce a relatively lower power output than the first electric motor 160′. As with the first electric motor 160′, the second electric motor 160″ may include a second mechanical link 184 (similar to the first mechanical link 180) which may be drivable by a stator/rotor arrangement of the second electric motor 160″. In contrast to the operations of the first electric motor 160′ where the first electric motor 160′ may receive electrical power or electric energy from the battery 124, the second electric motor 160″ may instead receive electrical power from the first electric motor 160′. Such reception of electrical power may occur during the deceleration event—exemplary working regarding such a reception is discussed later. Also, by way of receiving such electrical power, the second electric motor 160″ may produce a torque for driving the second mechanical link 184.

The flywheel 172 may be operatively coupled to the second mechanical link 184, and, accordingly, may be powered to rotate, e.g., when the second electric motor 160″ receives the electrical power from the first electric motor 160′. A rotation of the flywheel 172 may cause rotary energy to be stored within the flywheel 172, which may be available till a stoppage of a rotation of the flywheel 172. Although referred to in the singular, the flywheel 172 may be representative of multiple flywheels. Such multiple flywheels may be mechanically connected with each other, e.g., through a splined shaft, and/or in any other manner as may be contemplatable by someone skilled in the art. In some examples, the torque generated by the second electric motor 160″ may be transmitted to the flywheel 172 through a transfer case or a gear box (not shown). In some embodiments, a rotary speed sensor 188 may be provided and which may sense a rotational speed of the flywheel 172. In some embodiments, an encoder (not shown) may be provided within the second electric motor 160″ to detect the rotational speed.

The PDU 168 may be configured to connect all components of the powertrain 156 together electrically and distribute electrical power to one or more of said components of the powertrain 156 during operation. The PDU 168 may be in electrical communication with the battery 124 and thus may receive electrical power, e.g., directly, from the battery 124, during operations. The PDU may also receive electrical power from the first electric motor 160′and the second electric motor 160″, during operations. The PDU 168 may include one or more electrical circuits having various electrical components, such as wires, relays, and switches (not shown). Such circuits and components (collectively referred to as the PDU circuits) may be controlled by the first converter controller 164′ and the second converter controller 164″ to limit electrical power into and out of the first electric motor 160′and the second electric motor 160″.

The first converter controller 164′ may be positioned and/or communicatively coupled between the PDU 168 and the first electric motor 160′. The first converter controller 164′ may be configured to convert a power signal between AC and DC. As an example, when a power signal (e.g., a first DC power signal) is received by the first converter controller 164′ from the battery 124, e.g., during the acceleration event, the first converter controller 164′ may convert the first DC power signal received from the battery 124 from DC to AC for delivery of a first AC power signal to the first electric motor 160′. Conversely, when a power signal is received by the first converter controller 164′ from the first electric motor 160′, e.g., during the deceleration event, the first converter controller 164′ may convert a second AC power signal received from the first electric motor 160′ from AC to DC for delivery of a second DC power signal to the PDU 168. In some embodiments, the first converter controller 164′ may include a converter-inverter module (not shown) for the conversion any power signal between AC and DC. The first converter controller 164′ may limit electrical power into and out of the first electric motor 160′to control a rotational speed of the first electric motor 160′.

Similar to the first converter controller 164′, the second converter controller 164″ may be positioned and/or communicatively coupled between the PDU 168 and the second electric motor 160″. As with the first converter controller 164′, the second converter controller 164″ may be configured to convert a power signal between AC and DC, as well. As an example, when a power signal (e.g., a third DC power signal, which may be same as the second DC power signal) is received by the second converter controller 164″ from the first electric motor 160′, e.g., during the deceleration event, the second converter controller 164″ may convert the third DC power signal received from the PDU 168 from DC to AC for delivery of a third AC power signal to the second electric motor 160″. Conversely, when a power signal is received from the second electric motor 160″, during the acceleration event and/or the deceleration event, the second converter controller 164″ may convert a fourth AC power signal received from the second electric motor 160″ from AC to DC for delivery of a fourth DC power signal to the PDU 168. In some embodiments, the second converter controller 164″ may include a converter-inverter module (not shown) for the conversion any power signal between AC and DC. The second converter controller 164″ may limit electrical power into and out of the second electric motor 160″ to control a rotational speed of the second electric motor 160″.

In some embodiments, data from the encoder and/or the rotary speed sensor 188 may be used by the second converter controller 164″ to monitor a position and/or a state of the second electric motor 160″ and may also to provide the rotational speed of the second electric motor 160″.

The powertrain 156 and/or the system 176 associated with the powertrain 156 may further include a control system 192. The control system 192 may be communicable with each of the PDU 168, the first converter controller 164′, and the second converter controller 164″. The control system 192 may also be in communication with the battery 124 (and/or the BMS 128 associated with the battery 124) to receive data related to a state of the battery 124. The control system 192 may further be communicatively coupled with one or more controllers and/or sensors of the machine 100. As an example, the control system 192 may be communicatively coupled with a master controller 196 of the machine 100, with the battery temperature sensor 132 (which may be part of the BMS 128) of the battery 124, and with the encoder/the rotary speed sensor 188. Based on input received from the master controller 196 and/or the sensors, e.g., the battery temperature sensor 132 and the encoder/the rotary speed sensor 188, the control system 192 may be configured to perform a series of operations, as will be discussed below.

According to one or more aspects of the present disclosure and/or the series of operations, the control system 192 is configured to detect the deceleration event of the electrically driven load 136. The deceleration event may be detected based on a deceleration of the electrically driven load 136 registered by the master controller 196. Further, the control system 192 may also be configured to determine a battery charge rate limit of the battery 124, e.g., the battery charge rate limit may be determined by retrieving temperature data from the battery temperature sensor 132 and the battery's state of charge. Moreover, the control system 192 may be configured to cause, in response to the battery charge rate limit, at least a first part of the electrical power to power the second electric motor 160″ during the deceleration event. In so doing, inertia is generated in the second electric motor 160″ and/or in the flywheel 172 operatively coupled to the second electric motor 160″.

Such powering of the second electric motor 160″ may accommodate or facilitate a reduction of a charging rate of the battery 124 from the harnessed electrical power to a reduced charging rate. Further, such powering may allow the battery 124 to be charged/recharged with the reduced charging rate based on the inertia generated by the powering of the second electric motor 160″. The charging and/or recharging of the battery 124 with the reduced charging rate may continue during the deceleration event until a stoppage (e.g., of rotation) of the second electric motor 160″ and/or of the flywheel 172. Additionally, the control system 192 may be configured to cause at least a second part of the harnessed electrical power generated by the inertia to be returned to the first electric motor 160′ during an acceleration event of the electrically driven load 136, e.g., when the acceleration event occurs pursuant to the deceleration event and prior to the stoppage of the second electric motor 160″. Acceleration events of the electrically driven load 136, such as the one occurring in pursuance to the deceleration event and prior to the stoppage of the second electric motor 160″, may be registered at the master controller 196 and thus detected by the control system 192. The terms ‘first part’ and ‘second part’ used in relation to the harnessed electrical power is used considering parasitic losses, etc., may be sustained during transmission of the harnessed electrical power across the components of the powertrain 156.

The control system 192 may correspond to one or more controllers which may be communicably coupled to the master controller 196 of the machine 100. The master controller 196 of the machine 100 may in turn include and/or correspond to a safety module or a dynamics module of the machine 100, and/or the same may be configured as a stand-alone entity. Optionally, the control system 192 may be integral to or be one and the same as the master controller 196. In some embodiments, the control system 192 may be integral to and/or may be one and the same as one or more of the first converter controller 164′ and/or the second converter controller 164″. Also, it is possible that the functions performable by the master controller 196, as described herein, may be performable by the control system 192. In some embodiments, one or more controlling portions of the control system 192 may be situated within the machine 100, while the other controlling portions may be situated outside the machine 100, e.g., remotely to the machine 100. In some embodiments, the control system 192 may be positioned entirely outside the machine 100.

Further, the control system 192 may include a microprocessor-based device, and/or the control system 192 may be envisioned as an application-specific integrated circuit, or other logic devices, which provide controller functionality, and such devices or systems being known to those with ordinary skill in the art. In some embodiments, the set of instructions may be provided in any computer readable media, for example, any non-transitory computer readable media, and that when executed by the control system 192 may result in one or more of the functions of the control system 192, as described herein. The control system 192 may be in communicative communication with a memory 200 from which data, e.g., to determine the battery charge rate limit, one or more set of instruction based on which the control system 192 may perform its operations, etc., may be retrieved.

In one example, it is possible for the control system 192 to include or be representative of one or more controllers having separate or integrally configured processing units to process a variety of data, such as input or commands or signals incoming from the master controller 196, the battery temperature sensor 132, and the encoder/the rotary speed sensor 188. In some embodiments, a transmission of data between such components and the control system 192 and/or between the control system 192 and various other systems and/or devices, such as the first converter controller 164′ and the second converter controller 164″, may be facilitated wirelessly or through a standardized CAN bus protocol. Although not limited, the control system 192 may be optimally suited for accommodation within certain panels or portions, such as machine panels or portions, from where the control system 192 may remain accessible for ease of use, service, calibration, repairs, and/or replacements.

Processing units or any one or more processors associated with the control system 192 (and/or with the first converter controller 164′ and/or the second converter controller 164″), to convert or process various input, command, signals, etc., may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor now known or in the future developed.

Examples of the memory 200 may include a hard disk drive (HDD), and a secure digital (SD) card. Further, the memory 200 may include non-volatile/volatile memory units such as a random-access memory (RAM)/a read only memory (ROM), which may include associated input and output buses. The memory may be configured to store various other instruction sets for various other functions of the work machine, along with the set of instruction, described above. Although not limited, the memory 200 may be configured within and may form part of the control system 192, in some cases.

### Industrial Applicability

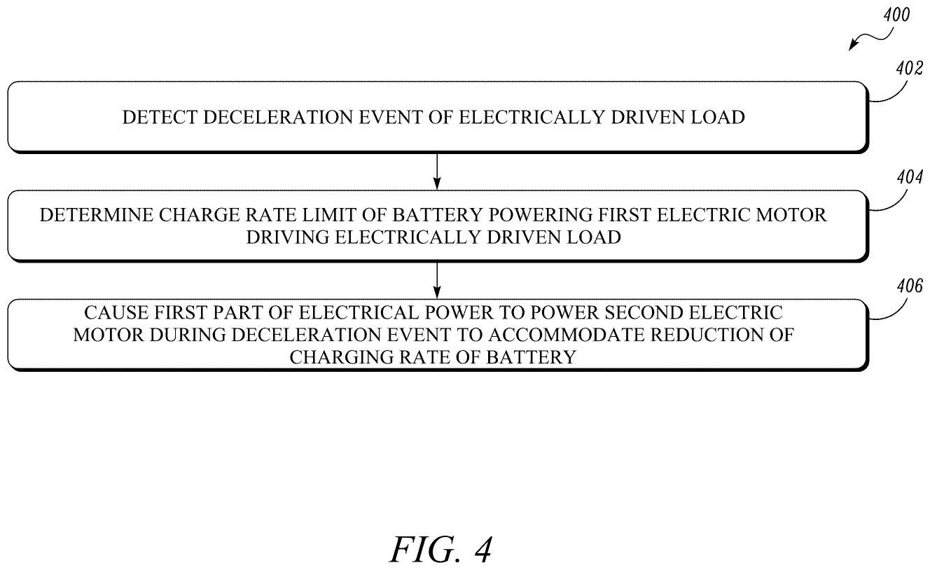

During operations, an operator of the machine 100 may cause the electrically driven load 136 to be powered on and thus accelerated at one or more instances to perform one or more machine functions, e.g., the compaction operation. During an acceleration of the electrically driven load 136, the PDU 168 may route electrical power from the battery 124 to the first electric motor 160′, such that the first electric motor 160′ may be powered to accelerate and perform as desired. However, as the electrically driven load 136 may be decelerated, the electrically driven load 136 may be powered down and/or may have its operational speed lowered. In case the electrically driven load 136 includes one or more of the traction devices 140, 140′, powering down or a lowering of the operational speed may mean a braking or a reversing operation of the machine 100. Such deceleration of the electrically driven load 136 may be registered by the master controller 196 of the machine 100. Further aspects of the present disclosure discusses an exemplary method for managing the harnessed electrical power from the electrically driven load 136 or the electrical regeneration from the first electric motor 160′, during such deceleration. The method is discussed by way of a flowchart 400 in FIG. 4, and also in conjunction with FIGS. 1 through 3. The method starts at block 402.

At block 402, the control system 192 may source or receive data corresponding to the deceleration of the electrically driven load 136 from the master controller 196. Such sourcing or reception of data may be performed as soon as the electrically driven load 136 decelerates and/or slows down during operations. In so doing, the control system 192 correspondingly detects a deceleration event of the electrically driven load 136. Once the deceleration event is detected and established by the control system 192, the control system 192 may retrieve a set of instructions from the memory 200. Further, the control system 192 may run the set of instructions. The method proceeds to block 404.

At block 404, and by way of running the set of instructions, the control system 192 may determine a battery charge rate limit of the battery 124. The battery charge rate limit may depend on a temperature condition of the battery 124. In this regard, as the control system 192 may be communicatively coupled with the battery temperature sensor 132, the control system 192 may receive temperature data from the battery temperature sensor 132. The reception of temperature data from the battery temperature sensor 132 may be continuous, periodic, and/or as required. Based on the temperature data, the control system 192 may determine the temperature condition. In one example, the temperature condition of the battery 124 may correspond to a condition when a temperature of the battery 124 is detected to have reduced or receded below a temperature threshold. The reduction or receding of the temperature of the battery 124 below the temperature threshold may indicate a functioning of the battery 124 in relatively cold conditions or regions that may create capacity constraints in the battery 124, warranting that the battery 124 be charged at a relatively lower charging rate than usual. The method proceeds to block 406.

At block 406, in response to the battery charge rate limit and/or temperature condition and/or to address the capacity constraint of the battery 124, the control system 192 may cause at least a part (e.g., a first part) of the harnessed electrical power to power the second electric motor 160″ during the deceleration event. To this end, the control system 192 may cause the third AC power signal to be received by the second electric motor 160″. Thus, to cause the first part of the harnessed electrical power to power the second electric motor 160″ during the deceleration event, the control system 192 routes said part of the harnessed electrical power to the second electric motor 160″ through the PDU 168. As a part (e.g., the first part) of the harnessed electrical power may be transferred to the second electric motor 160″, parts of the harnessed electrical power is shared between the battery 124 and the second electric motor 160″, e.g., in conjunction with the flywheel 172. More particularly, a reduction of a charging rate of the battery 124 from the harnessed electrical power to a reduced charging rate may be well accommodated and achieved. The method stops at block 406.

Also, as a result of the transfer of the harnessed electrical power to the second electric motor 160″, the second electric motor 160″ may be powered to run and/or rotate. With the transfer of a part of the harnessed electrical power to the second electric motor 160″, the second electric motor 160″ may begin to rotate the second mechanical link 184 and/or the flywheel 172, thus generating inertia at the second electric motor 160″. In process of doing so, rotational energy may be stored within the second electric motor 160″ and/or the flywheel 172. Also, the battery 124 may be charged/recharged with the reduced charging rate based on the inertia generated by powering the second electric motor 160″ until a stoppage (e.g., of rotation) of the second electric motor 160″ or of the flywheel 172 during the deceleration event. The control system 192 may instruct the PDU 168 to supply the fourth DC power signal, at least in part, to the battery 124 in response to the deceleration event to charge/recharge the battery 124 with the reduced charging rate. It will be noted that the reduced charging rate may be lower than a prespecified or any predetermined charging rate.

The control system 192 may cause at least a second part of the electrical power generated by the inertia to be returned to the first electric motor 160′ during an acceleration event of the electrically driven load 136, e.g., when the acceleration event occurs pursuant to the deceleration event and prior to the stoppage (of free running or rotation) of the second electric motor 160″. The free running may occur owing to and/or during a dissipation of energy stored in the flywheel 172. To this end, the control system 192 may instruct the PDU 168 to supply the fourth DC power signal, at least in part, towards the first electric motor 160′in response to the acceleration event. As a part (e.g., second part) of the harnessed electrical power may be transferred or returned to the first electric motor 160′ during the acceleration event, the battery 124 may be refrained from receiving any electrical power for the most portion of such an acceleration event. The second part of the harnessed electrical power may be transferred during the acceleration event until the stoppage of the second electric motor 160″ and/or the flywheel 172.

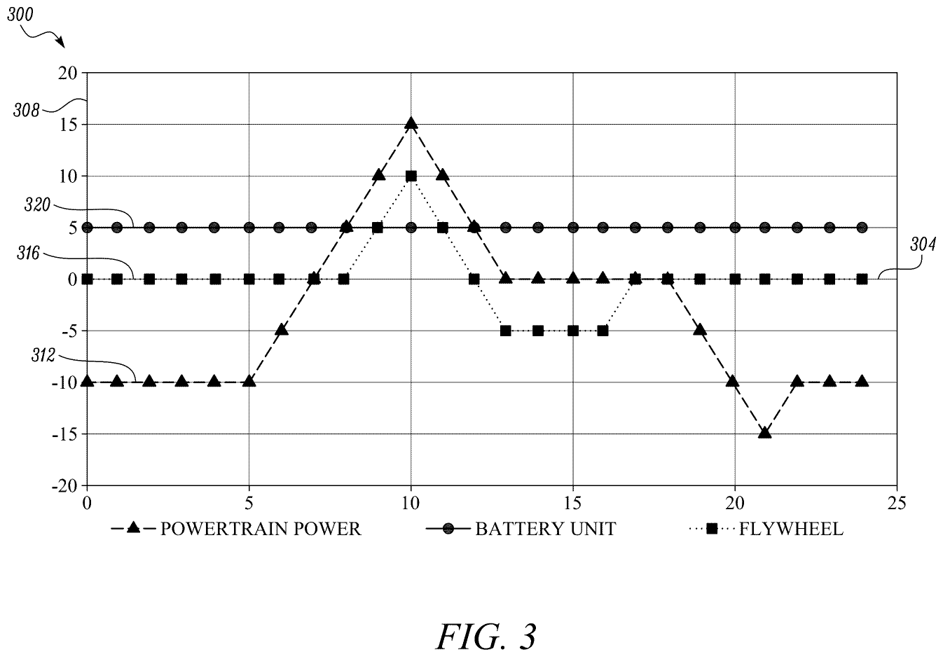

Referring to FIG. 3, a graphical representation 300 indicates an exemplary manner in which the harnessed electrical power from the electrically driven load 136 is managed and/or optimized. For reference, the graphical representation 300 includes X-axis 304 on which time is plotted exemplarily in seconds and Y-axis 308 on which electrical power is plotted exemplarily in Kilowatt (kW). Further, the graphical representation 300 includes three (3) curves, namely a first curve 312 indicating electrical power variation in relation to the electrically driven load 136; a second curve 316 indicating electrical power variation in relation to the second electric motor 160″ and/or the flywheel 172; and a third curve 320 indicating the capacity constrain of the battery 124 or a battery limit. Exemplarily, the battery limit in the graphical representation 300 may be set at 5 kW. All values described in connection with the graphical representation 300 are provided for illustrative purposes only and may include other values in actual application.

As shown in the graphical representation 300, it may be noted that for the time period, 0-5 seconds, the electrically driven load 136 consumes 10 kW power; for a subsequent the time period, 5-13 seconds, the deceleration event is detected and the electrically driven load 136 causes power generation (also referred to as electrical regeneration) in the first electric motor 160′ during the deceleration event. Within the time period 5-13 seconds, for the time period, 9-11 seconds, the second electric motor 160″ and/or the flywheel 172 may consume excess power due to the battery limit. Further, for the time period, 13-16 seconds, the second electric motor 160″ and/or the flywheel 172 may charge the battery 124, e.g., with the reduced charging rate.

In further detail, at the 8^{th} second, the electrical regeneration from the electrically driven load 136 may charge the battery 124 at the battery limit—e.g., at 5 kW; at the 9^{th} second, the electrical regeneration from the electrically driven load 136 may exceed the battery limit—e.g., 5 kW power may be supplied to battery 124 and 5 kW may be supplied to the flywheel 172; at the 10^{th} second, the electrical regeneration from the electrically driven load 136 may exceed the battery limit—e.g., 5 kW power may be supplied to battery 124 and 10 kW may be supplied to the flywheel 172; at the 11^{th} second, the electrical regeneration from the electrically driven load 136 may exceed the battery limit—e.g., 5 kW power may be supplied to battery 124 and 5 kW may be supplied to the flywheel 172; at the 12^{th} second, the electrical regeneration from the electrically driven load 136 may may charge the battery 124 at the battery limit—e.g., at 5 kW.

Further, from 13 through 16 seconds, the electrical regeneration from the electrically driven load 136 may become negligible and/or may fall to zero (0), however, the second electric motor 160″ and/or the flywheel 172, from 13 through 16 seconds, may charge the battery 124 at battery limit—e.g., at 5 kW; and from 17 through 18 seconds, the acceleration event may be detected by the control system 192, the electrical regeneration from the electrically driven load 136 may become negligible and/or may fall to zero (0), and the second electric motor 160″ and/or the flywheel 172 may stop operation, providing power neither to the battery 124, nor to the first electric motor 160′.

In relatively cold temperatures, transfer of excess power (e.g., the harnessed electrical power by way of electrical regeneration) into the battery 124 (which may be a Lithium-Ion battery) may be restricted during deceleration events. The system 176 including the second electric motor 160″ (in conjunction with the flywheel 172) provides for receiving such excess power in such instances/events, allowing the electrically driven load 136 to decelerate and/or stop timely. Additionally, the system 176 and method (discussed by way of the flowchart 400) also allows the second electric motor 160″ (in conjunction with the flywheel 172) to return at least a part of said excess power to the first electric motor 160′, e.g., during the acceleration event occurring pursuant to the deceleration event and prior to the stoppage of the second electric motor 160″ and/or the flywheel 172. In that manner, the system 176 optimally manages the harnessed electrical power during declaration events, thus prolonging battery life while also ensuring efficient operation of the electrically driven load 136.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the disclosure, especially in the context of the following claims, are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method or system of the present disclosure without departing from the scope of the disclosure. Other embodiments will be apparent to those skilled in the art from consideration of the specification and practice of the method or system disclosed herein. It is intended that the specification and examples be considered as examples only, with a true scope of the disclosure being indicated by the following claims and their equivalent.

What is claimed is:

1. A method for managing electrical power harnessed from an electrically driven load in a machine, the method comprising:
detecting, by a control system, a deceleration event of the electrically driven load;
determining, by the control system, a battery charge rate limit of a battery powering a first electric motor driving the electrically driven load;
causing, by the control system, in response to the battery charge rate limit, at least a first part of the electrical power to power a second electric motor during the deceleration event to accommodate a reduction of a charging rate of the battery from the electrical power to a reduced charging rate.

2. The method of claim 1, wherein at least the first part of the electrical power powers the second electric motor during the deceleration event to recharge the battery with the reduced charging rate based on an inertia generated by powering the second electric motor until a stoppage of the second electric motor.

3. The method of claim 2, the method further includes: causing, by the control system, at least a second part of the electrical power generated by the inertia to be returned to the first electric motor during an acceleration event of the electrically driven load, wherein the acceleration event occurs pursuant to the deceleration event and prior to the stoppage of the second electric motor.

4. The method of claim 1, wherein
the battery charge rate limit depends on a temperature condition of the battery, wherein the temperature condition corresponds to a condition when a temperature of the battery is detected to have reduced below a temperature threshold and indicates a capacity constrain of the battery to receive the electrical power during the deceleration event at the reduced charging rate, and
the reduced charging rate is lower than a prespecified charging rate.

5. The method of claim 3, wherein causing at least the first part of the electrical power to power the second electric motor during the deceleration event includes routing, by the control system, at least the first part of the electrical power to the second electric motor through a power distribution unit.

6. The method of claim 5 further including:
using a first converter controller communicatively coupled between the first electric motor and the power distribution unit, the method includes:
converting, by the first converter controller, during the acceleration event, a first Direct Current (DC) power signal received from the battery from DC to Alternating Current (AC) for delivery of a first AC power signal to the first electric motor; and
converting, by the first converter controller, during the deceleration event, a second AC power signal received from the first electric motor from AC to DC for delivery of a second DC power signal to the power distribution unit; and
using a second converter controller communicatively coupled between the second electric motor and the power distribution unit, the method includes:
converting, by the second converter controller, during the deceleration event, a third DC power signal received from the power distribution unit from DC to AC for delivery of a third AC power signal to the second electric motor; and
converting, by the second converter controller, during the acceleration event or the deceleration event, a fourth AC power signal received from the second electric motor from AC to DC for delivery of a fourth DC power signal to the power distribution unit.

7. The method of claim 6 further including:
instructing, by the control system, the power distribution unit to supply the fourth DC power signal, at least in part, to the battery in response to the deceleration event; and
instructing, by the control system, the power distribution unit to supply the fourth DC power signal, at least in part, towards the first electric motor in response to the acceleration event.

8. The method of claim 6 further including using one or more flywheels operatively coupled to the second electric motor to store energy from a powering of the second electric motor when the third AC power signal is received by the second electric motor.

9. A system for managing electrical power harnessed from an electrically driven load in a machine, the system comprising:
an auxiliary electric motor to be operably coupled to a main electric motor powered by a battery to drive the electrically driven load;
a control system configured to:
detect a deceleration event of the electrically driven load;
determine a battery charge rate limit of the battery;
cause, in response to the battery charge rate limit, at least a first part of the electrical power to power the auxiliary electric motor during the deceleration event to accommodate a reduction of a charging rate of the battery from the electrical power to a reduced charging rate.

10. The system of claim 9, wherein the control system is configured to cause, in response to the battery charge rate limit, at least the first part of the electrical power to power the auxiliary electric motor during the deceleration event to recharge the battery with the reduced charging rate based on an inertia generated by powering the auxiliary electric motor until a stoppage of the auxiliary electric motor.

11. The system of claim 9, wherein the control system is configured to cause at least a second part of the electrical power generated by the inertia to be returned to the main electric motor during an acceleration event of the electrically driven load, wherein the acceleration event occurs pursuant to the deceleration event and prior to the stoppage of the auxiliary electric motor.

12. The system of claim 9, wherein
the battery charge rate limit depends on a temperature condition of the battery, wherein the temperature condition corresponds to a condition when a temperature of the battery is detected to have reduced below a temperature threshold and indicates a capacity constrain of the battery to receive the electrical power during the deceleration event at the reduced charging rate, and
the reduced charging rate is lower than a prespecified charging rate.

13. The system of claim 11, wherein to cause at least the first part of the electrical power to power the auxiliary electric motor during the deceleration event, the control system is configured to route at least the first part of the electrical power to the auxiliary electric motor through a power distribution unit.

14. The system of claim 13 further including:
a first converter controller communicatively coupled between the main electric motor and the power distribution unit, the first converter controller configured to:
convert, during the acceleration event, a first Direct Current (DC) power signal received from the battery from DC to Alternating Current (AC) for delivery of a first AC power signal to the main electric motor; and
convert, during the deceleration event, a second AC power signal received from the main electric motor from AC to DC for delivery of a second DC power signal to the power distribution unit; and
a second converter controller communicatively coupled between the auxiliary electric motor and the power distribution unit, the second converter controller configured to:
convert, during the deceleration event, a third DC power signal received from the power distribution unit from DC to AC for delivery of a third AC power signal to the auxiliary electric motor; and
convert, during the acceleration event or the deceleration event, a fourth AC power signal received from the auxiliary electric motor from AC to DC for delivery of a fourth DC power signal to the power distribution unit.

15. The system of claim 14, wherein the control system is configured to:
instruct the power distribution unit to supply the fourth DC power signal, at least in part, to the battery in response to the deceleration event; and
instruct the power distribution unit to supply the fourth DC power signal, at least in part, towards the main electric motor in response to the acceleration event.

16. The system of claim 14 further including one or more flywheels operatively coupled to the auxiliary electric motor to store energy from a powering of the auxiliary electric motor when the third AC power signal is received by the auxiliary electric motor.

17. A machine, comprising:
a battery;
an electrically driven load to perform work;
a main electric motor powered by the battery to drive the electrically driven load;
a system for managing electrical power harnessed from the electrically driven load, the system including:
an auxiliary electric motor operably coupled to the main electric motor; and
a control system configured to:
detect a deceleration event of the electrically driven load;
determine a battery charge rate limit of the battery;
cause, in response to the battery charge rate limit, at least a first part of the electrical power to power the auxiliary electric motor during the deceleration event to accommodate a reduction of a charging rate of the battery from the electrical power to a reduced charging rate.

18. The machine of claim 17, wherein
the battery charge rate limit depends on a temperature condition of the battery, wherein the temperature condition corresponds to a condition when a temperature of the battery is detected to have reduced below a temperature threshold and indicates a capacity constrain of the battery to receive the electrical power during the deceleration event at the reduced charging rate, and
the reduced charging rate is lower than a prespecified charging rate.

19. The machine of claim 17, wherein the control system is configured to:
cause, in response to the battery charge rate limit, at least the first part of the electrical power to power the auxiliary electric motor during the deceleration event to recharge the battery with the reduced charging rate based on an inertia generated by powering the auxiliary electric motor until a stoppage of the auxiliary electric motor; and
cause at least a second part of the electrical power generated by the inertia to be returned to the main electric motor during an acceleration event of the electrically driven load, wherein the acceleration event occurs pursuant to the deceleration event and prior to the stoppage of the auxiliary electric motor.

20. The machine of claim 19 further including one or more flywheels operatively coupled to the auxiliary electric motor to store energy from a powering of the auxiliary electric motor during the deceleration event.
